(19) United States
(12) Patent Application Publication
(10) Pub. No.: US 2005/0025907 A1
(43) Pub. Date: Feb. 3, 2005

(54) Plaque for displaying three dimensional item

(76) Inventor: Kevin Stepka, St. Paul, MN (US)

Correspondence Address: KAGAN BINDER, PLLC;Maple Island Building, Suite 200, 221 Main Street North, Stillwater, MN, 55082, US

(21) Appl. No.: 10/898,014

(22) Filed: Jul. 21, 2004

Related U.S. Application Data
(60) Provisional application No. 60/488,873, filed on Jul. 21, 2003.

(51) Int. Cl. B32B 3/10

(52) U.S. Cl. 428/14; 428/137

(57) ABSTRACT

A plaque having the ability to hold a three dimensional item for display, and in particular to a plaque with one or more display features for holding the item and permitting display of more than one surfaces of such a three dimensional item. In another aspect, plaque designs related to a specific type of event are combined with items of the same event.

### REFERENCE TO RELATED APPLICATIONS

This application claims the benefit of U.S. Provisional application Ser. No. 60/488,873, filed Jul. 21, 2003, entitled, “PLAQUE FOR DISPLAYING THREE DIMENSIONAL ITEM,” which application is incorporated herein by reference in its entirety.

### TECHNICAL FIELD

The present invention is directed to a plaque having the ability to hold a three dimensional item for display, and in particular to a plaque with one or more display features for holding the item and permitting display of more than one surfaces of such a three dimensional item.

### BACKGROUND OF THE INVENTION

The present invention has particular applicability to the display of sports memorabilia, as such are commonly three dimensional items that are used within a sport. Moreover, such items often have many surface features of interest and that may include additional display features such as autographs and the like. Such sports memorabilia may include items like balls (as used in baseball, football, soccer, golf, etc), hockey pucks, sporting equipment, clothing (e.g. jerseys, hats, gloves, etc), accessories, or the like. These items are more difficult to display, in general, in that they have three dimensional features as opposed to the well known display of two dimensional pictures, cards, prints, and the like by conventional framing techniques or as incorporated into a plaque design. Other three dimensional items that may be desirably displayed include collectibles of any type.

Picture framing techniques have been applied to such three dimensional items by creating a box-like structure within a picture frame having spaced backing and display surfaces within which the item(s) can be mounted and displayed. Such techniques allow substantially two-dimensional display of a chosen surface of such an item. That is, even though an item may not actually be flat as a two dimensional object (e.g. a ball, puck or other collectible), it is displayed generally in that sense as being viewable generally perpendicularly to the front frame surface, which is typically transparent and made of glass or plastic to permit viewing from that direction.

Mostly, three dimensional items are supported for display in racks or display cases of many varieties in order to provide greater viewability than with picture frames. That is, racks and display cases having shelves or other support platforms are known whereby the displayed objects can more easily be seen from different angles. Such racks and display cases typically provide support structure for one or more items for display, but are generally characterized by a generic nature with respect to the individual items supported therein. So, although a rack or display case may be generally related to a sport, such as hockey or golf, for example, they would not typically be related to one specific event as related to one of the items supported therein. Moreover, such racks and display cases do not mount the individual items for display as is more typically achieved by picture framing or plaque mounting techniques.

Plaques for three dimensional items have also been developed. Plaques are primarily designed for hanging on a wall so, as such, are generally flat in nature and exhibit any displayed item and/or commemorative aspect on a front major surface thereof. The nature of a plaque is typically to add a commemorative aspect, such as by adding description, date or any other information having a relevance to the item mounted or provided as part of the plaque. That is, unlike a rack or display case, a plaque typically relates a commemorative aspect to the individual nature of the item(s) supported therein. Moreover, with prior art plaque designs, the item is mounted to a surface of the plaque to be viewable along with the commemorative aspect thereof. As to sports items, in particular, plaque mounting is difficult in that the item to be mounted must have a flat surface, or the plaque must be modified to receive the item. Modifications can be done by way of recesses or other receiving structure either within the plaque thickness or by way of an intermediate structure provided between the item and the plaque surface, such as mounting pads, pins, frames and the like. Moreover, adhesives and the like are typically utilized in such mountings. An example of a sports collectible that is easily mounted is a hockey puck because it has two major flat surfaces, either of which can be adhered to a flat plaque surface, which results in a loss of the ability to view the mounted puck surface.

### BRIEF DESCRIPTION OF THE DRAWINGS

FIG. 1 is a perspective view of a plaque for supporting an item to be viewable from the plaque front or back;

FIG. 2 is a perspective view similar to FIG. 1 with a hockey puck supported by the plaque;

FIG. 3 is a front view of the plaque and hockey puck combination of FIG. 2;

FIG. 4 is a back view of the plaque and hockey puck combination of FIG. 2;

FIG. 5 is an exploded view in perspective of an item to be removably supported within a transparent enclosure;

FIG. 6 is a front view of a plaque supporting a plurality of items combined with specific and general indicia plates;

FIG. 7 is a back side view of the plaque of FIG. 6;

FIG. 8 is a front view of a hockey puck supported on a plaque of a design related to the item supported;

FIG. 9 is a front view of a plurality of hockey pucks supported on a plaque design related to the items supported;

FIG. 10 is a front view of another related plaque design with plural items supported thereon;

FIG. 11 is a cross-sectional view of a plaque with a through hole supporting an item within a case, the case having a design flange;

FIG. 12 is a further design aspect where the item supported is related to the design of the supporting plaque simulating an action of the related sport; and

FIG. 13 is an enlarged view of a portion of FIG. 12 with the item supported in position.

### DESCRIPTION OF EMBODIMENTS OF THE PRESENT INVENTION

The present invention is directed to plaque designs that make use of the commemorative aspect associated with plaques but also add better viewability of an item mounted thereto, particularly where the item has three dimensional aspects. Preferably, the item is mounted with a plaque so that a plurality of surfaces thereof can be visible. Also, plaque designs in accordance with the present invention can be designed with features indicative of the sport or other nature of any such collectable as an enhancement to the commemorative aspect of such plaque design.

The present invention is applicable to the display of collectable items of any type wherein one or more three dimensional item is also to be mounted to a plaque of any design. In particular, the present invention provides for the mounting of a three dimensional item to a plaque so as to permit viewing of plural surfaces of the item from oppositely facing major surfaces of the plaque. Although the present invention finds particular applicability to sports memorabilia as may be collected and displayed on a plaque design, it is contemplated that any other three dimensional object can be likewise mounted and displayed. For the purposes of specific examples described below, hockey pucks are discussed and illustrated with the understanding that other three dimensional objects could be otherwise utilized, as many such types of other items are discussed above in the Background section.

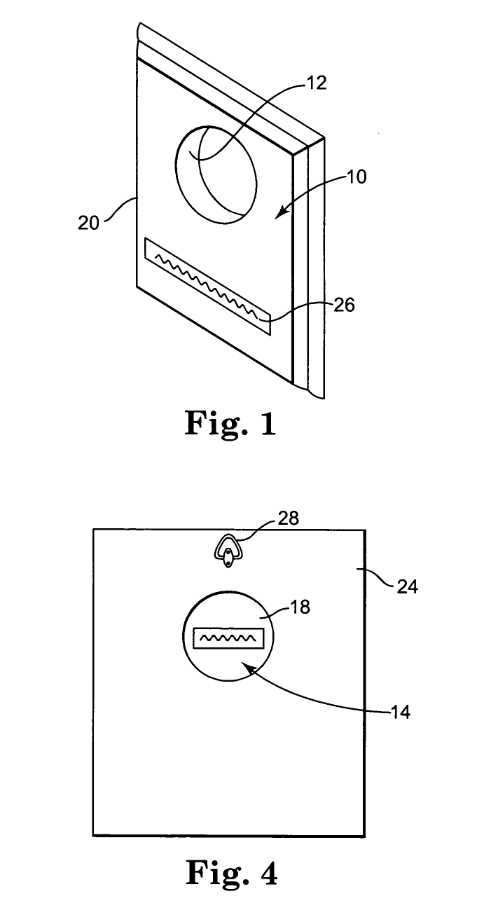

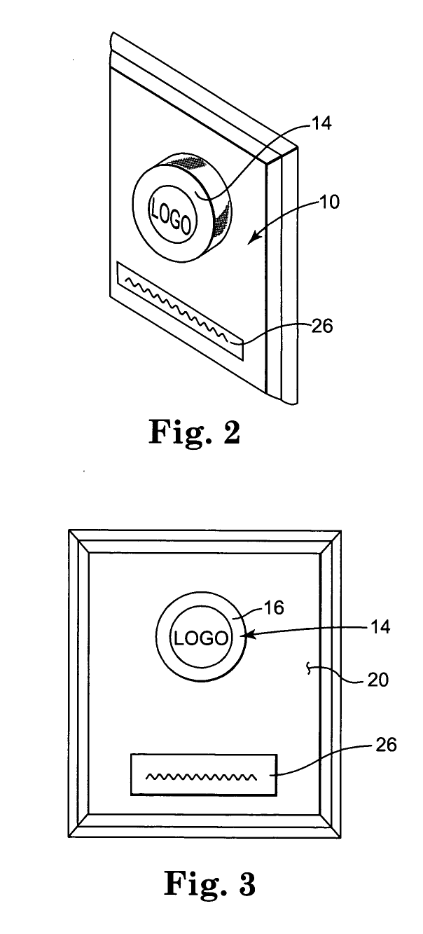

FIG. 1 shows a plaque 10 having an opening 12 for supporting a hockey puck 14 as illustrated in FIG. 2. In accordance with one aspect of the present invention, it is preferable that opening 12 be provided entirely through the thickness of plaque 10 so that a hockey puck 14 can have both of its major surfaces 16 and 18 positioned to be viewable when looking at opposite front and back sides 20 and 24 of the plaque 10 as shown in FIGS. 3 and 4. As shown in FIG. 3, for example, a hockey puck front surface 16 is shown depicted with a logo design while in FIG. 4 the puck back surface 18 is shown with other indicia, such as may provide information about the puck or an autograph or the like. The plaque 10 as also illustrated with a typical information plate 26 as may be provided as a commemorative aspect of the plaque 10. Such information plates 26 are well-known themselves and it is contemplated that any number of such features may be provided. Moreover, any other types of known or developed commemorative aspects may be added to the plaque 10 as desirable.

The hockey puck 14 is preferably mounted within opening 12 by way of a friction fit so that the puck 14 can be removed as desired for viewing or the like or for replacement by another puck or the like at a later time. Such a friction fit can be modified or enhanced by the provision of material between an edge of the hockey but 14 and the surface defining opening 12. For example, one or more bands can be provided about the puck 14 to increase the diameter thereof and thus affect the friction fit within opening 12. Any type of rigid or flexible rings or bands can be used for such purpose If a permanent mounted is desired, such a fit can be enhanced with adhesive or the like as well. Likewise, mechanical clamps or fixation devices can be used to connect the puck 14 with the plaque 10, such as to hold the puck 14 within the opening 12 so as to be removable or not. For items other than hockey pucks, it is contemplated that other fit enhancement features can be utilized in a similar manner. Moreover, with a plaque designed for sporting one or more hockey pucks, a puck 14 can be inserted within opening 12 to any depth (within or beyond the depth of the opening 12), but preferably to a point where the back surface 18 is substantially in plane with the back surface 24 of plaque 10. That way, the plaque 10 can be hung on a wall in a conventional manner, such as by way of hanger 28 illustrated in FIG. 4.

The frontside appearance of the puck 14 and plaque 10 can also be enhanced by covering the interface between the puck side and the plaque 10 around the opening 12. For example, a bead of sealant or caulk could be provided around the puck 14 as supplied as a flexible strip or from a tube. Alternatively, a ring of plastic, metal, wood, or the like can be provided in a similar manner as moulding is used in cabinetry. Or, a decorative strip can be wrapped around such interface. Any such ring or strip can be adhered or otherwise connected to the puck 14 and/or the plaque 10, which connection can be used to partially or wholly secure the puck 14 in place to the plaque 10. Any decorative surface can be provided to such ring, strip or bead as desired.

The plaque 10 itself can be comprised of any material as are known or developed for plaque display purposes including, for example, woods, plastics and metals. Opening 12 can be provided as part of a forming process or by providing a through bore through the thickness of plaque 10. It is contemplated, however, that instead of using a through bore, support for an item, such as hockey puck 14, can be provided by a similarly shaped recess (where a surface is provided within the thickness of the plaque 10). However, such a mounting would lose the ability for viewing of the hockey puck 14 from the back surface 24 of the plaque 10. The plaque 10 can also be of any conventional or developed construction itself including multiple layers as may be desirable for design or other purposes.

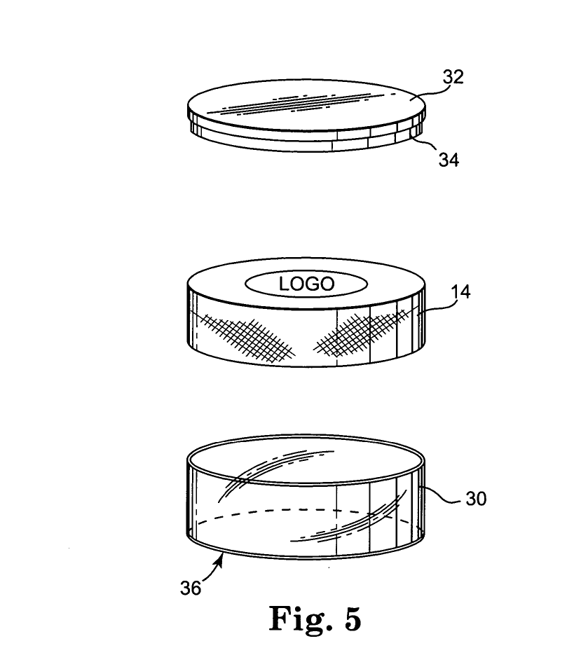

FIG. 5 illustrates another embodiment of how a hockey puck 14 or other item can be supported within a plaque 10. Specifically, puck 14 can be positioned within a case 30 and the case 30 can be sized, or modified in size as discussed above, to be friction fit or otherwise mounted within an opening 12 or recess of a plaque 10. Preferably, a lid 32 is also utilized for encasing the puck 14, which lid 32 is illustrated with a flange 34 to fit within the opening diameter of the case 30, such as by friction or with mechanical interference. Such a case 30 and lid 32 enclose the puck 14 for mounting within a plaque 10. Preferably, at least a portion of the lid 32 is transparent, although it is more preferable that the lid 32 and case 30 be completely transparent including, in particular, the bottom surface 36 so that the entire puck is viewable in the manner as supported within plaque 10 and discussed above. It is contemplated that a case may be of a different shape than the item supported therein and that other devices or mediums may be provided also within the case for support or design purposes.

The use of a case 30 permits the puck 14 or other items to be more easily removable even where the case 30 may be permanently installed to the plaque 10. The lid 32 can be provided to give access to the case interior from either the front or back side of the plaque 10 once the case 32 is secured to the plaque 10 either removably or permanently.

As above, some or all of the interface between the case 32 and the plaque 10 around opening 12 can be enhanced by a bead of material, strip material, or a ring. By providing such a case 32, however, a ring feature can be incorporated within the case structure as provided from the lid 32 or case 30. FIG. 11 shows a case 300 with a lid 320 where the case 300 is fit within the opening 12 of a plaque 10. The lid 320 is shown removable from the back side 24 of the plaque 10 to permit puck 14 to be removable even when the case 300 is permanently secured within opening 12, such as by adhesive, fasteners, or the like. Case 300 also is integrated with a flange portion 330 that covers the interface of the case 300 and plaque 10 around opening 12 in the same way as would a separate element, strip, ring or bead. The external surface 332 of flange 330 can be shaped, colored or otherwise decorated in any way as desired for appearance effects. Inside surface 334 can be used in securing the case 300 to the plaque 10 and advantageously also functions as a stop to locate the case 300 within the depth of the opening 12 of plaque 10. The lid 320 could be formed instead with an integral flange and used in a similar manner. Alternatively, both the case 300 and lid 320 could have an integral flange so that they would sandwich and thus effectively clamp the case 300 in place to the plaque 10.

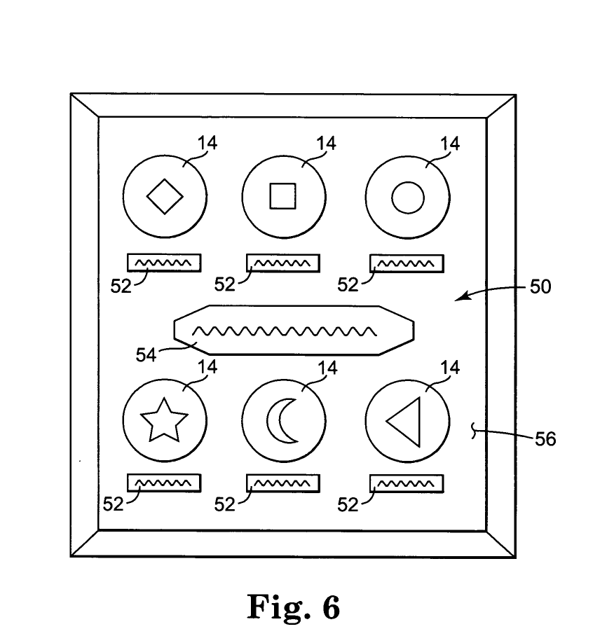

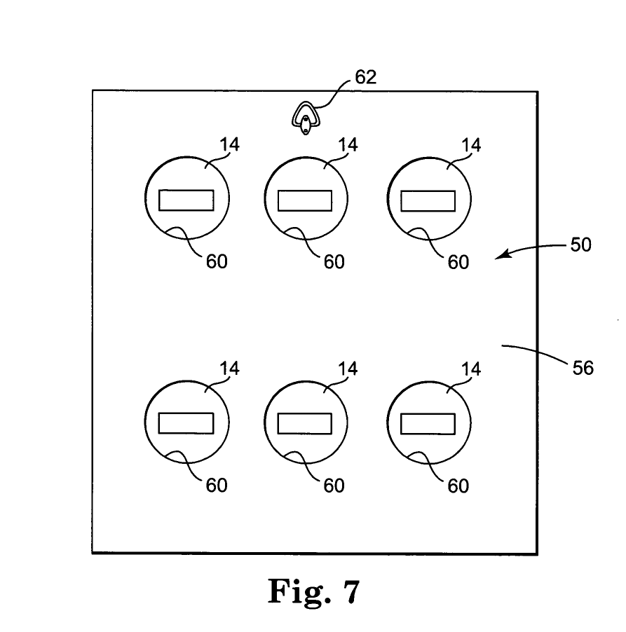

As shown in FIGS. 6 and 7, it is also contemplated that any number of items, of which a plurality of hockey pucks 14 are illustrated, can be provided within the design of a plaque 50. FIG. 6 shows the plaque 50 supporting six different hockey pucks 14 in accordance with one arrangement including indicia plates 52 associated with each puck 14 along with a further indicia plate 54 possibly of a more general nature or the like. FIG. 6 illustrates just one arrangement of which any number can easily be suggested. For example, any number of indicia plates or other design or commemorative features or aspects can be provided in addition to any number of supported items. Moreover, the plaque itself can comprise any shape. FIG. 6 shows how each puck can be displayed with a design aspect on a first major surface thereof facing in the same direction as a plaque front surface 56. FIG. 7 shows a similar view from a back side surface 58 of plaque 50 wherein the pucks 14, as supported by an arrangement of through bores 60, permits viewing of the second major surfaces thereof facing the same direction as the plaque back surface 58. A conventional hanger device 62 is also illustrated so that such a plaque 50 can be hung on a wall as desired. It is contemplated that a plaque in accordance with the present invention having more than one support opening or recess can be provided with features to facilitate the collection of such items over time, and that such plaques may be expandable or connectible with other similarly provided plaques as part of a collection process. In any case, individuals can create their own plaque by combining any number of items as they choose in a way so that two sides thereof are visible, such as by manipulating and viewing front and back sides of the plaque. Such a design also permits the removal of one puck, for example, from the plaque for further viewing or replacement by another adding to the individual customization by each person. Protection for the items can be provided by utilizing any number of cases, such as described above, and as such may include transparent covers and/or other case features for positioning or decorative effect.

Where one or more support cases are used to hold a puck or other item to the plaque 10, it is contemplated that the case could be secured directly to a surface, such as front surface, of a plaque as may be provided in any manner suggested above or as below with related plaque designs. Such a case could be adhered, or attached by mechanical fasteners in place to give a similar effect, although viewing of a second surface of the item may be lost.

The designs in accordance with the present invention are also particularly useful in making wall hanging plaques. However, plaques in accordance with the present invention can be made or include other features to be otherwise supported. For example, a pivoted support element (not shown) can be provided from the plaque back surface to provide support for the plaque in the manner of a tabletop picture frame as such are well-known. Any number of other support possibilities are contemplated as well.

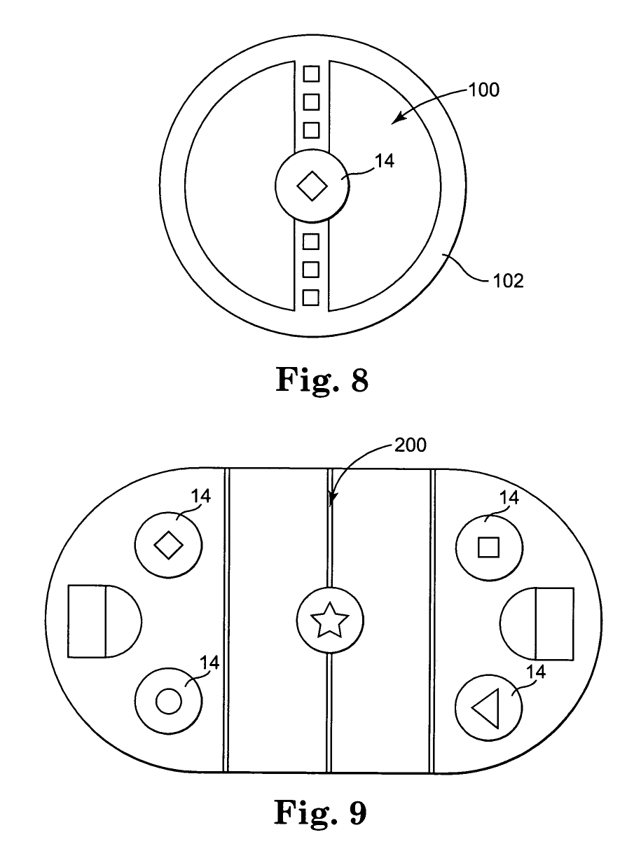

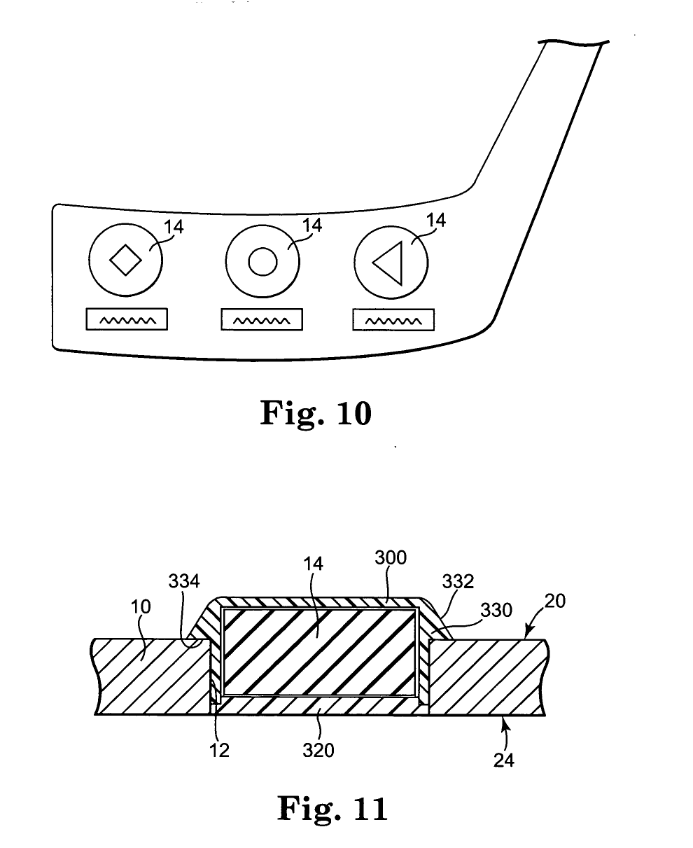

FIGS. 8 and 9 illustrated yet another aspect of the present invention where one or more items, such as pucks 14 are supported on plaques having design aspects related to the supported items. For example, in FIG. 8, a puck 14 is illustrated supported near the center of a circular plaque 100 that is designed to look like a center face-off circle 102 of a hockey rink. To simulate an ice surface and face-off circle, a white background could be provided with the circle 102 and centerline in red. FIG. 9 illustrates, as another example, a plaque 200 simulating a hockey rink with pucks 14 supported at each of the face-off circles that are typically provided on a hockey rink. FIGS. 8 and 9 illustrate just a couple of examples in accordance with this aspect of the present invention wherein one or more items are combined with a plaque having design features related to be supported items. For other type collectibles, similar relationships can be envisioned and incorporated within a plaque design for supporting one or more related items thereon. Although not necessary in accordance with this aspect of the present invention, it is preferable that the items, such as pucks 14, be supported as described above so that a plurality of surface portions thereof are viewable from the front and back sides of the plaques. As with the plaques described above, it is also contemplated that any number of additional commemorative aspects can be incorporated within these designs. FIG. 10 illustrates yet another contemplated design, which like FIGS. 8 and 9, incorporates a plaque shape aspect into the overall plaque design. FIG. 8 simulates a face-off circle and as such is shown as a circular shape. FIG. 9 simulates a hockey rink and as such a shown as an extended oval. FIG. 10 simulates a portion of a hockey stick. Like the designs described above, any number of pucks 14 with any other commemorative aspects or other design features can be combined.

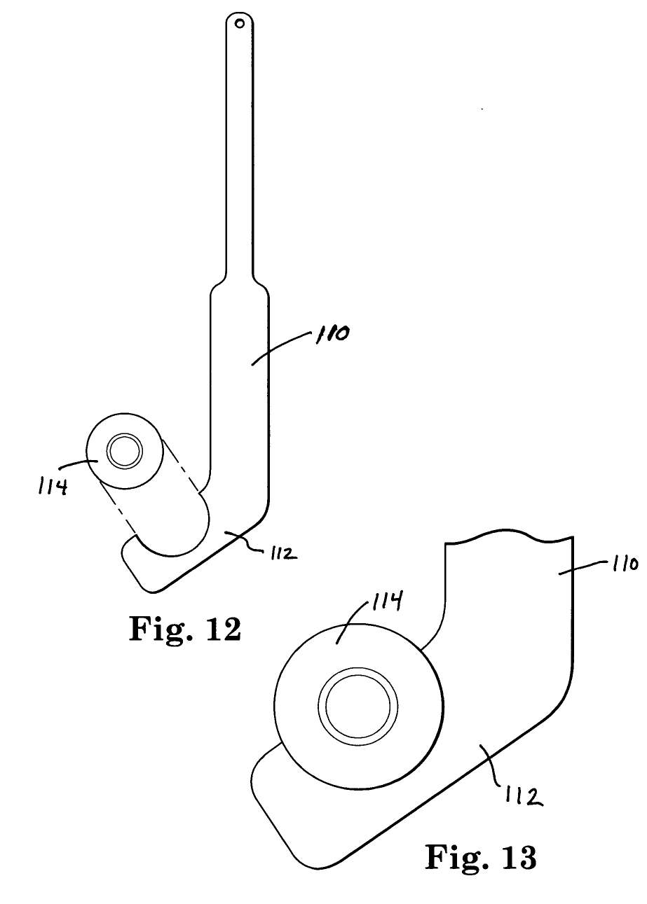

Like the designs of FIGS. 8, 9 and 10 having design aspects related to the supported item, an action design is illustrated in FIGS. 12 and 13 combining a hockey puck 114 and a hockey stick 110 as a related plaque shape. Moreover, by selectively positioning the puck 114 to the blade 112 of the hockey stick 110, an action of shooting a puck is simulated. Such appearance is enhanced by the puck 114 being supported partially on or within the blade 112 and partially off the blade 112, although such is not necessary.

In FIG. 12, the hockey stick 110 includes an opening 116 provided as a part of a circle to accommodate the shape of a hockey puck 114. The opening 116 is open through one edge of the blade 112 of the hockey stick 110. Then, a puck 114 can be effectively secured within the opening 116 in any manner discussed and suggested above.

The opening 116 can comprise a full circle within the hockey stick blade 112 or a partial circle as illustrated. Any portion of a puck 114 can be accommodated by a respective circle portion created by an opening 116. As shown in FIG. 13, puck 114 is positioned within opening 116 to simulate the action of shooting a puck. The puck 114 can be adhered along a portion or more of its perimeter to the edge of the opening 116 based upon the thickness of blade 112. Mechanical fasteners or the like could otherwise be used. The puck 114 could otherwise be fit within a recess of the blade instead of a through-opening in the same way, but could also be secured at a back surface of the puck 114. Alternatively, the puck 114 could be simply secured to the surface of the blade 112 to get a similar effect, although there would be some loss of the ability to view the puck back side.

Preferably, a case like that described above in FIG. 5 is also used for providing puck 114 to the blade 112. The puck 114 would be positioned in such a case as may have any of the features suggested above, and then the case would be secured to the blade 112 either by use of the opening 116, a recess, or to a surface of the blade, where adhesives, mechanical fasteners, or any other conventional or developed securement technique could be used.

The present invention includes plaque designs that are particularly suitable for displaying three-dimensional plate items, such as sports memorabilia, in a plaque construction as may be hangable a wall or otherwise supported. Preferably, such items can be supported so as to be viewable from both major sides of such a plaque construction. Preferred designs also include plaque features and shapes that simulate related aspects of the supported item(s). The plaque can be made to have as many item support openings desired or could be related to an order placed by a person to hold the number of pucks that have been ordered from a manufacturer or supplier. Such a plaque can be provided to display such items and in any shape and size. For example and as described above, a hockey stick with a hole in the blade to fit a puck would have the appearance of a puck on the blade of the stick. Another example could be a special holiday plaque with a holiday puck that comes in the shape of the holiday puck displayed. For example, a Christmas puck set into a plaque in the shape of a Christmas tree. One more example could be a plaque of a net painted on a plaque piece with a hole in it to show a puck being scored into a net. Also, a plaque in accordance with the present invention may include any number of additional features whether related to the displayed item or not. For example, clock features (e.g. hour and second hands) can be incorporated into a design.

1. A plaque comprising a base having at least one opening passing through a thickness of the base, the opening being sized and shaped to receive and support a three dimensional item to the plaque and for permitting viewing of the item when supported within the base from either major side of the base.

2. The plaque of claim 1, in combination with an item as supported within the opening of the base.

3. The plaque of claim 2, further including a case that at least partially encloses the item as supported to the plaque.

4. The plaque of claim 3, wherein the case includes a lid that encloses the entire item and the lid and a case bottom are at least partially transparent to permit viewing of the item as supported by the plaque from both sides thereof.

5. The plaque of claim 4, further comprising a plurality of openings and supporting a plurality of items on the plaque.

6. The plaque of claim 5, wherein the items comprise hockey pucks.

7. The plaque of claim 6, wherein a plaque front surface also includes a commemorative feature thereon.

8. The plaque of claim 7, wherein the plaque front surface also includes at least one design feature related to the hockey pucks, the design feature having a shape or appearance simulating an aspect of the game of hockey.

9. A method of displaying an item on a plaque comprising the steps of providing a plaque with at least one opening passing through a thickness of the plaque and supporting an item to the plaque by inserting at least a portion of the item within the opening, so that a plurality of surfaces of the item are visible from opposite sides of the plaque.

10. The method of claim 9, wherein the item supported is a hockey puck and further including steps of viewing opposite front and back puck surfaces by turning the plaque over from a front to a back surface.

11. A plaque comprising a base having a design that is related to and based upon a particular type of event in combination with an item that is also related to the same type of event, wherein the item is supported in position at least partially with respect to a surface of the plaque.

12. The combination of claim 11, wherein the plaque is shaped to simulate an aspect of the type of event.

13. The combination of claim 12, wherein the plaque is also provided with graphics related to the type of event.

14. The combination of claim 13, wherein the item is supported within an opening through the plaque at least partially defining a perimeter of the supported item.

15. The combination of claim 13 wherein the plaque is designed to simulate at least one of an implement use din the type of event and at least a portion of an event playing area.

16. The combination of claim 15, wherein the item comprises a hockey puck and the plaque design simulates one of a hockey playing implement and at least a portion of a hockey rink.

17. The combination of claim 16, wherein the plaque design comprises a shape of at least a portion of a hockey stick with the puck supported on at least a portion of a hockey stick blade.

18. The combination of claim 17, wherein the puck is contained within a at least partially transparent enclosure that is secured to the plaque.

19. The combination of claim 18, wherein the enclosure is supported within an opening of the hockey stick blade.

20. The combination of claim 19, wherein the puck within the enclosure is supported so that at least a portion of the perimeter of the enclosure and puck lie outside of the hockey stick shape.
